(19) United States
(12) Patent Application Publication
(10) Pub. No.: US 2021/0100374 A1
(43) Pub. Date: Apr. 8, 2021

(54) INTELLIGENT MEAL DELIVERY SYSTEM

(71) Applicant: Kuang-Chen LO, Taichung City (TW)

(72) Inventor: Kuang-Chen LO, Taichung City (TW)

(21) Appl. No.: 16/876,669

(22) Filed: May 18, 2020

(30) Foreign Application Priority Data
Oct. 4, 2019 (TW) 108136081

(51) Int. Cl. A47F 10/06; A47G 23/08

(52) U.S. Cl. CPC A47F 10/06; A47G 23/08

(57) ABSTRACT

An intelligent meal delivery system is adapted to be used in a restaurant and includes a rail device, a delivering vehicle and an operating device. The delivering vehicle is movable along a rail of the rail device and is adapted to deliver the foods from a pick-up region to the access regions of the restaurant, and includes a locomotive carrier including a carrier plate adapted for carrying the foods, and a controller device configured to control the locomotive carrier. The operating device is communicatively connected to a controller module of the controller device and is operable to transmit an instruction to the controller module. The controller module is configured to control the delivering vehicle according to the instruction.

### CROSS-REFERENCE TO RELATED APPLICATION

This application claims priority of Taiwanese Invention Patent Application No. 108136081, filed on Oct. 4, 2019.

### FIELD

The disclosure relates to a device for delivering foods to tables, more particularly to an intelligent meal delivery system.

### BACKGROUND

Referring to FIGS. 1 and 2, Taiwanese Patent No. I645817 discloses a conventional automatic meal delivery system adapted to be used to deliver foods (not shown) in a restaurant 9 including a pick-up region 91 and a plurality of access regions 92. The conventional meal delivery system 1 includes a rail unit 11, a delivering train 12, and a central control unit 13.

The rail unit 11 includes a rail 111, and a plurality of position tags 112 disposed on the rail 111 and spaced apart from one another along the rail 111. The delivering train 12 is movable along the rail 111, and includes a locomotive 121 and a plurality of cars 122 connected to and driven to move by the locomotive 121. Each of the cars 122 are adapted to carry the foods. The locomotive 121 has a detector (not shown) for detecting the position tags 112. The central control unit 13 is disposed at the pick-up region 91 and for transmitting an instruction to the locomotive 121 and to determine whether the foods are placed on the cars 122. The instruction includes a delivery path and and a plurality of delivery positions located on the delivery path and corresponding to a plurality of the position tags 112. When the locomotive 121 receives the instruction, it departs from the pick-up region 91 and moves on the rail 111 along the delivery path until the detector of the locomotive 121 detects a first one of the position tags 112 that corresponds to one of the delivery positions, i.e., the locomotive 121 has reached one of the delivery positions, after which the locomotive 121 stops, waits until the food on the corresponding car 122 is removed, then continues to drive the cars 122 to move along the delivery path until the next delivery position is reached.

Because the locomotive 121 of the delivering train 12 of the conventional meal delivery system is only used to drive the cars 122 and is not designed to carry the foods, the delivering train 12 is relatively long, and thus may extend out of the pick-up region 91 or take up unnecessary space on the rail 111.

The rail 111 includes a plurality of cycle tracks 113 connected sequentially and each having an outbound section 114, an inbound section 115, and a U-shaped return section 116 connected between the outbound and inbound sections 114, 115. When the locomotive 121 drives the cars 122 from one cycle track 113 to an adjacent cycle track 113, each one of the cars 122 would temporarily not be supported by the rail 111 when passing through the junction of the return section 116 and the outbound sections 114 of the cycle tracks 113 or when passing through the through junction of the return section 116 and the inbound sections 115 of the cycle tracks 113. At this point, if the locomotive 121 were to stop, said car 122 might collide with the locomotive 121 or other cars 122 and tilt and drift, potentially disturbing the food placed on said car 122. Moreover, when the delivery train 12 passes through the return section 116 of one of the cycle tracks 113, centrifugal force might also cause the cars 122 to drift and tilt and also disturb the food on the cars 122.

### SUMMARY

Therefore, the object of the disclosure is to provide an intelligent meal delivery system that can alleviate the drawback of the prior art.

According to the disclosure, an intelligent meal delivery system is adapted to be used in a restaurant including a pick-up region and a plurality of access regions for delivering foods. The meal delivery system includes a rail device, a delivering vehicle, and an operating device.

The rail device includes a rail and a plurality of position tags. The rail is adapted to be disposed in the restaurant, is adapted to extend along a path along which the access regions are arranged, and includes an outbound portion, an inbound portion and a return portion interconnecting the outbound portion and the inbound portion. The position tags are disposed on the rail and are spaced apart from one another along the rail.

The delivering vehicle is movable along the rail, is adapted to deliver the foods from the pick-up region to the access regions, and includes a locomotive carrier and a controller device.

The locomotive carrier includes a bottom seat, a carrier plate disposed on and above the bottom seat in a height direction and adapted for carrying the foods, and a main wheel set disposed on and under the bottom seat.

The main wheel set includes a chassis plate pivotally connected to the bottom seat and rotatable about a vertical axis so as to allow the bottom seat to steer, two main wheels respectively disposed on lateral sides of the chassis plate, and two motors respectively driving the main wheels to rotate such that the locomotive carrier moves along the rail.

The controller device is mounted to the locomotive carrier, is configured to control the locomotive carrier, and includes a detector module that detects the position tags, a controller module that is electrically connected to the detector module and the motors and that is configured for controlling the motors to drive the main wheels to rotate and controlling the detector module to detect the position tags, and a battery set that is electrically connected to the motors, the detector module and the controller module to provide electricity thereto.

The operating device is communicatively connected to the controller module of the controller device, and includes an operating portion that is communicatively connected to the control module and that is operable to transmit an instruction to the controller module.

The controller module is configured to control the delivering vehicle according to the instruction.

### BRIEF DESCRIPTION OF TH DRAWINGS

Other features and advantages of the disclosure will become apparent in the following detailed description of the embodiments with reference to the accompanying drawings, of which:

FIG. 1 is a schematic top view of a conventional automatic meal delivery system disclosed in Taiwanese Patent No. I645817;

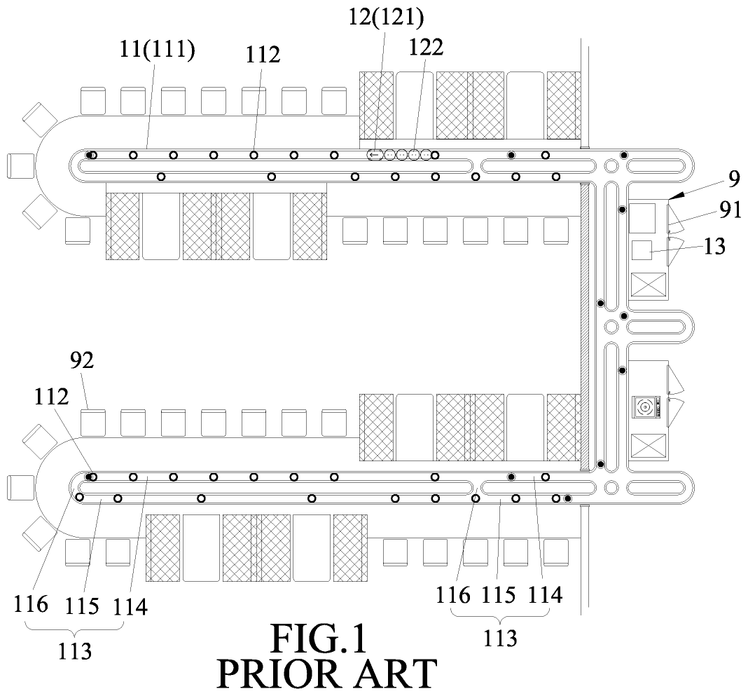

FIG. 2 is a fragmentary perspective view, illustrating a delivery train moving along a rail of the conventional meal delivery system;

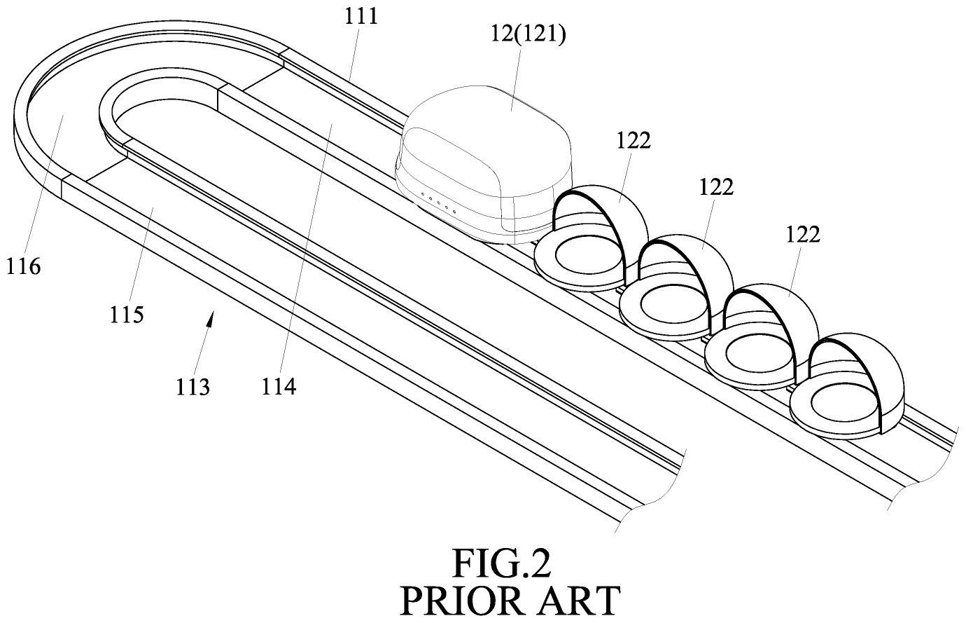

FIG. 3 is a schematic top view of a first embodiment of an intelligent meal delivery system of the disclosure adapted to be used in a restaurant;

FIG. 4 is a fragmentary perspective view illustrating a delivering vehicle of the first embodiment on a charging stand of a rail device of the first embodiment;

FIG. 5 is an exploded perspective view of the delivering vehicle of the first embodiment;

FIG. 6 is a perspective view of the delivering vehicle of the first embodiment;

FIG. 7 is a perspective view of a delivering vehicle of a second embodiment of the intelligent meal delivery system of the disclosure; and

FIG. 8 is another fragmentary perspective view of the delivering vehicle of the second embodiment.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

To aid in describing the disclosure, directional terms may be used in the specification and claims to describe portions of the present disclosure (e.g., front, rear, left, right, top, bottom, etc.). These directional definitions are intended to merely assist in describing and claiming the disclosure and are not intended to limit the disclosure in any way.

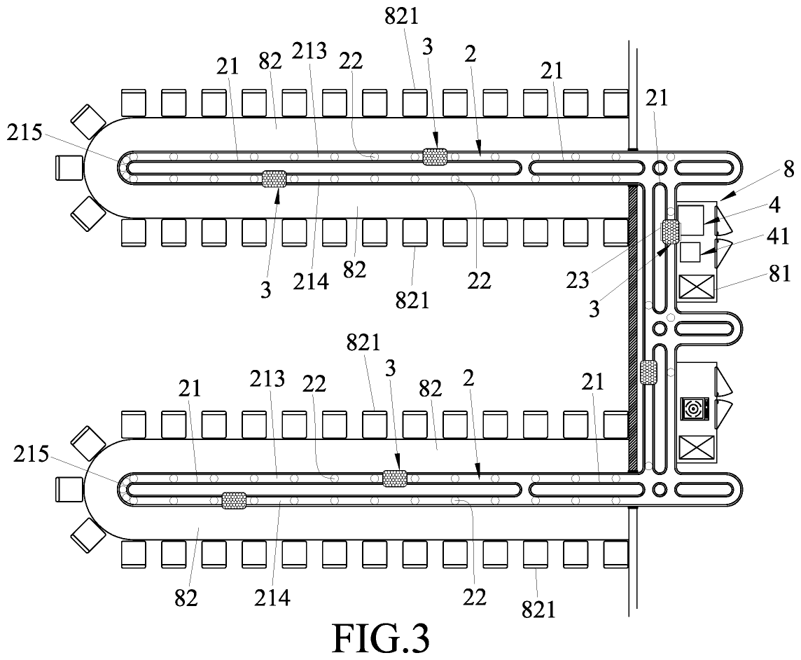

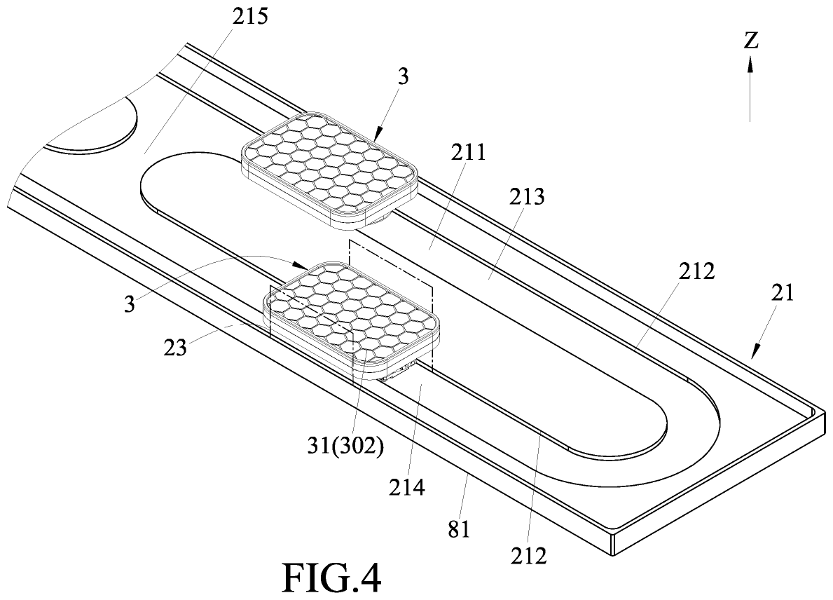

Referring to FIGS. 3 and 4, a first embodiment of an intelligent meal delivery system is adapted to be used in a restaurant including a pick-up region 81 and a plurality of access regions 82 for delivering foods (not shown). The meal delivery system includes at least one rail device 2, at least one delivering vehicle 3, an operating device 4, and an input device 5.

The rail device 2 includes a rail 21, and a plurality of position tags 22. The rail 21 is adapted to be disposed in the restaurant, is adapted to extend along a path along which the access regions 82 are arranged, and includes inner and outer side walls 212a, 212b horizontally apart from each other to define a U-shaped guideway 211 therebetween for guiding movement of the delivering vehicle 3. The rail 21 has an outbound portion 213, an inbound portion 214 and a U-shaped return portion 215 interconnecting the outbound portion 213 and the inbound portion 214.

The position tags 22 are disposed on the rail 21 and are spaced apart from one another along the rail 21. The position tags 22 are disposed corresponding in position respectively to a plurality of seating areas 821 of the access region 82. In this embodiment, the rail device 2 further has a charging station 23 adapted to be disposed in the pick-up region 81 and disposed on the rail 2 for charging the delivering vehicle 3.

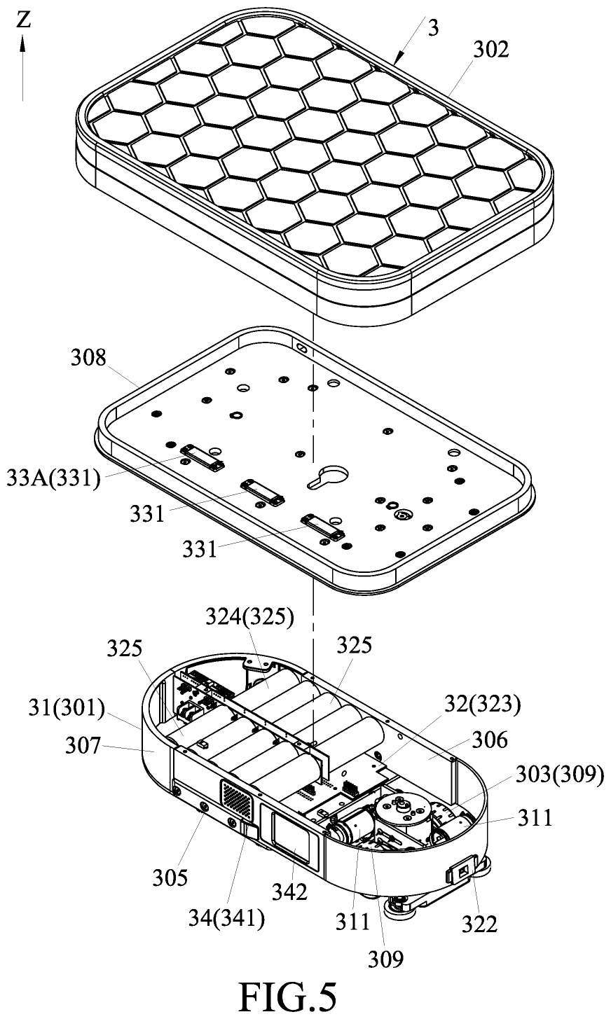

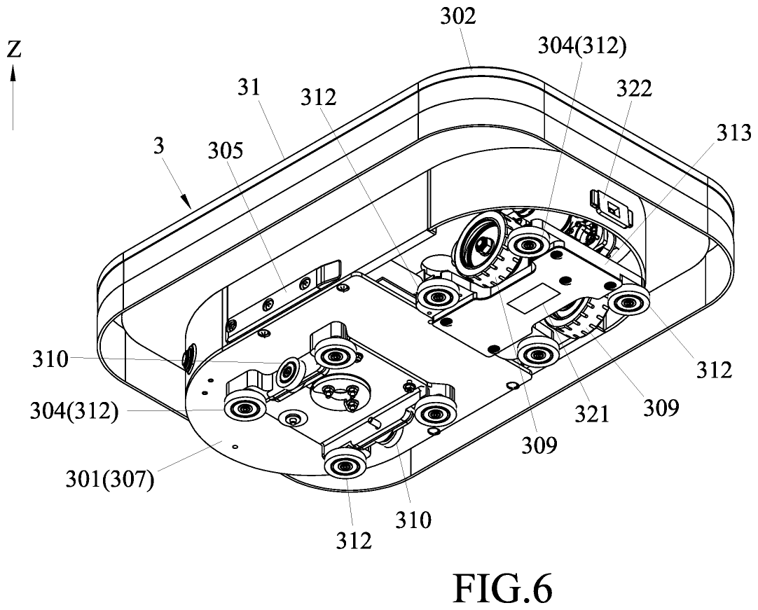

Referring to FIGS. 4 to 6, the delivering vehicle 3 is movable along the rail 21, is adapted to deliver the foods from the pick-up region 81 to the access regions 82, and includes a locomotive carrier 31, a controller device 32, a first weighting unit 33A, and an indicating unit 34.

The locomotive carrier 31 includes a bottom seat 301, a carrier plate 302 disposed on and above the bottom seat 301 in a height direction (Z) and adapted for carrying the foods, a main wheel set 303 disposed on and under the bottom seat 301, a plurality of guiding wheel sets 304, and two charging electrodes 305. The bottom seat 301 defines a receiving space 306 and has a lower casing 307 and an upper casing 308 covering the lower casing 307.

The main wheel set 303 includes a chassis plate 313 pivotally connected to the bottom seat 301 and rotatable about a vertical axis so as to allow the bottom seat 301 to steer, two main wheels 309 respectively disposed on lateral sides of the chassis plate 313, two assistive wheels 310 disposed on a rear side of the lower casing 307, and two motors 311 disposed in the receiving space 306 and respectively driving the main wheels 309 to rotate such that the locomotive carrier 31 moves along the rail 21. The main wheels 309 and the assistive wheels 310 are rotatable on the rail 21. When the locomotive carrier 31 is at the return portion 215 of the rail 21, a speed at which the main wheel 309 which is proximal to the outer side wall 212b is driven to rotate by a corresponding one of the motors 311 is quicker than that of the main wheel 309 which is proximal to the inner side wall 212a so that the chassis plate 313 can rotate smoothly.

The guiding wheel sets 304 are mounted to the bottom seat 301 and the chassis plate 313. Each of the guiding wheel sets 304 includes at least one auxiliary wheel 312 rotatable about an axis parallel to the height direction (Z) and being in contact with one of the inner and outer side walls 212 of the rail 21 to facilitate movement of the locomotive carrier 31 along the rail 21. In this embodiment, the locomotive carrier 31 includes four of the guiding wheel sets 304 respectively proximal to the main wheels 309 and the assistive wheels 310, each of the guiding wheel sets 304 includes two of the auxiliary wheels 312, and the auxiliary wheels 312 of each of the guiding wheel sets 304 proximal to the main wheels 309 flank the corresponding main wheel 309. In other embodiments, the guiding wheel sets 304 may be disposed on lateral sides of the lower casing 307 and each includes one of the auxiliary wheels 312. The charging electrodes 305 are disposed respectively on lateral outer surfaces of the locomotive carrier 31.

In this embodiment, the guideway 211 has a horizontal width smaller than that of the locomotive carrier 31 so as to minimize the area taken up by the guideway 211 in the restaurant for efficient use of space.

Referring to FIGS. 3, 5, and 6, the controller device 32 is mounted to the locomotive carrier 31, is disposed inside the receiving space 306, is configured to control the locomotive carrier 31, and includes a detector module 321, an obstacle detecting module 322, a controller module 323, and a battery set 324.

The detector module 321 is for detecting the position tags 22. The obstacle detecting module 322 is communicatively connected to the controller module 323 and configured to detect whether or not an obstacle (not shown) is disposed in front of the delivering vehicle 3 in a direction that the delivering vehicle 3 moves. The controller module 323 is electrically connected to the motors 311, the detector module 321 and the obstacle detecting module 322. The controller module 323 stores a delivery map including a plurality of position codes that correspond respectively to the position tags 22. Each of the position codes includes information about one of the seating areas 821 that corresponds in position to the respective one of the position tags 22. The controller module 323 is configured for controlling the motors 311 to drive the main wheels 309 to rotate, controlling the detector module 321 to detect the position tags 22, and controlling the motors 311 to stop driving the main wheels 309 when the obstacle detecting module 322 detects an obstacle. The battery set 324 is electrically connected to the motors 311, the detector module 321 and the controller module 323 to provide electricity thereto, and is electrically connected to the charging electrodes 305. In this embodiment, the battery set 324 has a plurality of super capacitors 325 and the charging station 23 charges the battery set 324 through connection with the charging electrodes 305. In other embodiments, wireless charging may be used, or the battery set 324 may use single-use batteries to provide power which renders the charging station 23 obsolete.

The first weighting unit 33A is disposed between the upper casing 308 of the bottom seat 301 and the carrier plate 302, and includes at least one first weight sensor 331 disposed under the carrier plate 302, electrically connected to the controller module 323, and adapted for measuring the total weight of the carrier plate 302 and the foods placed thereon so as to output a weight signal to the controller module 323 accordingly. The controller module 323 is configured to determine whether or not an object is disposed on the carrier plate 302 according to the weight signal received from the first weight sensor 331, so as to control the motors 311 accordingly. In this embodiment, the first weighting sensor 331 includes a plurality of first weighting sensors 331 to improve precision of the measurement of weight.

The indicating unit 34 is disposed on an outer surface of the bottom seat 301 and electrically connected to the control module 323. The indicating unit 34 includes a buzzer 341 for emitting sound and a display 342 for displaying a status of the delivering vehicle 3. The display 342 is capable of displaying information about the delivering vehicle 3 such as the power level, or malfunctioning of a portion of the delivering vehicle 3.

The operating device 4 is communicatively connected to the controller module 323 of the controller device 32, and includes an operating portion 41 communicatively connected to the control module 323 and operable to transmit an instruction to the controller module 323. The controller module 323 is configured to control the delivering vehicle 3 according to the instruction. The instruction transmitted from the operating portion 41 of the operating device 4 includes one of the position codes. The controller module 323 is configured to control the motors 311 to move the locomotive carrier 31 toward one of the position tags 22 corresponding to the one of the position codes included in the instruction, and to control the motors 311 to stop driving the main wheels 309 when the detector module 321 detects the one of the position tags 22 corresponding to the one of the position codes included in the instruction.

During operation of the meal delivery system, the delivering vehicle 3 first waits at the pick-up region 81 when the foods to be delivered is prepared. While idle at the pick-up region 81, the delivering vehicle 3 may be charged by the charging station 23 so that additional time is not needed. Next, the foods to be delivered is placed on the carrier plate 302 of the delivering vehicle 3, and then the operating portion 41 is operated to transmit an instruction to the controller module 323. When the instruction is received by the controller module 323, the controller module 323 controls the delivering vehicle 3 to move along the rail 21 toward one of the position tags 22 corresponding to one of the position codes included in the instruction. When the detector module 321 detects the one of the position tags 22 corresponding to one of the position codes included in the instruction, the controller module 323 commands the motors 311 to cease driving the main wheels 309 so that the delivering vehicle 3 stops at a corresponding one of the seating areas 821, and commands the buzzer 341 to emit a noise to notify a customer at the corresponding seating areas 821. When the controller module 323 determines from the weighting signal transmitted from the first weighting unit 33A that the foods have been removed from the carrier plate 302, the controller module 323 commands the motors 311 to start driving the main wheels 309 so that the delivering vehicle 3 continue to move along the rail 21.

In this embodiment, the at least one rail device 2 includes a plurality of the rail devices 2 and the at least one delivering vehicle 3 includes a plurality of the delivering vehicles 3. Each of the delivering vehicles 3 is controlled separately to delivery the foods to an indicated seat.

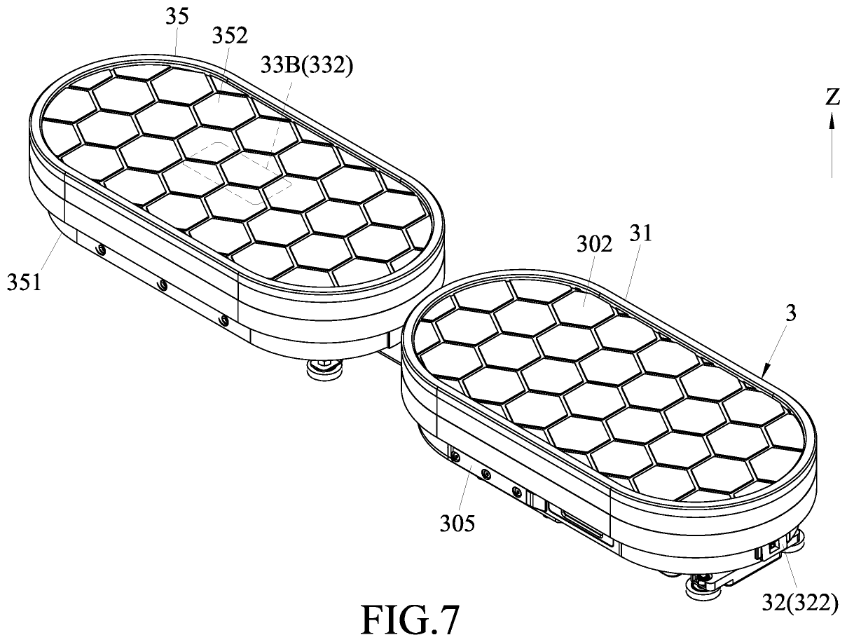

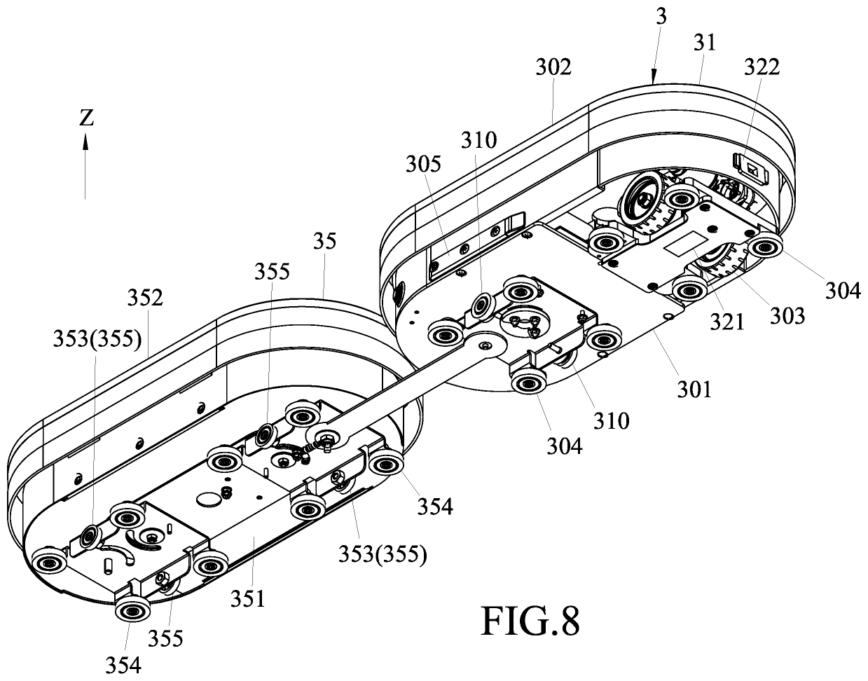

Referring to FIGS. 7 and 8, a second embodiment of the meal delivery system is similar to the first embodiment, but differs in that each of the delivering vehicles 3 further includes at least one driven carrier 35 and at least one second weighting unit 33B. For each of the delivering vehicles 3, the driven carrier 35 is drawn by the locomotive carrier 31 to move along a corresponding one of the rails 21 of the rail devices 2, and includes a bottom seat 351, a carrier plate 352 disposed on and above the bottom seat 351 in the height direction (Z) and adapted for carrying the foods, and two driven wheel sets 353 disposed on and under the bottom seat 351 in the height direction (Z) and rotatable along the corresponding rail 21. Each of the driven wheel sets 353 includes a plurality of spaced-apart driven wheels 355 rotatable on a corresponding one of the rails 21. In this embodiment, for each of the delivering vehicles 3, the at least one driven carrier 35 includes one driven carrier 35, but in other embodiments may include a plurality of driven carriers 35 as long as the total length of each of the delivering vehicles 3 does not exceed the size of the pick-up region 81 (see FIG. 3)

For each of the delivering vehicles 3, the second weighting unit 33B is disposed between the bottom seat 351 and the carrier plate 352 of the driven carrier 35, and includes a second weight sensor 332 disposed under the carrier plate 352 of the driven carrier 35, electrically connected to the controller module 323, and adapted for measuring the total weight of the driven carrier 35 and the foods placed thereon so as to output a weight signal to the controller module 323 accordingly. Each of the controller module 323 is configured to determine whether or not an object is disposed on a corresponding one of the carrier plate 352 according to the weight signal received from a corresponding one of the second weight sensor 332 and to control corresponding ones of the motors 311 accordingly.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An intelligent meal delivery system adapted to be used in a restaurant including a pick-up region and a plurality of access regions for delivering foods, said meal delivery system comprising:
a rail device including
a rail that is adapted to be disposed in the restaurant, that is adapted to extend along a path along which the access regions are arranged, and that includes an outbound portion, an inbound portion and a return portion interconnecting said outbound portion and said inbound portion, and
a plurality of position tags that are disposed on said rail and that are spaced apart from one another along said rail;
a delivering vehicle movable along said rail, adapted to deliver the foods from the pick-up region to the access regions, and including
a locomotive carrier that includes
a bottom seat,
a carrier plate disposed on and above said bottom seat in a height direction and adapted for carrying the foods, and
a main wheel set disposed on and under said bottom seat, and including a chassis plate that is pivotally connected to said bottom seat and that is rotatable about a vertical axis so as to allow said bottom seat to steer, two main wheels that are respectively disposed on lateral sides of said chassis plate, and two motors that respectively drive said main wheels to rotate such that said locomotive carrier moves along said rail,
a controller device mounted to said locomotive carrier, configured to control said locomotive carrier, and including a detector module that detects said position tags, a controller module that is electrically connected to said detector module and said motors and that is configured for controlling said motors to drive said main wheels to rotate and controlling said detector module to detect said position tags, and a battery set that is electrically connected to said motors, said detector module and said controller module to provide electricity thereto; and
an operating device communicatively connected to said controller module of said controller device, and including an operating portion that is communicatively connected to said control module and that is operable to transmit an instruction to said controller module, said controller module being configured to control said delivering vehicle according to the instruction.

2. The intelligent meal delivery system according to claim 1, wherein said controller device further includes an obstacle detecting module communicatively connected to said controller module and configured to detect whether or not an obstacle is disposed in front of said delivering vehicle in a direction that said delivering vehicle moves, said controller module being configured to control said motors to stop driving said mainwheels when said obstacle detecting module detects an obstacle.

3. The intelligent meal delivery system according to claim 1, wherein said delivering vehicle further includes a first weighting unit disposed between said bottom seat and said carrier plate, and including a first weight sensor that is disposed under said carrier plate, that is electrically connected to said controller module, and that is adapted for measuring the total weight of said carrier plate and the foods placed thereon so as to output a weight signal to said controller module accordingly, said controller module being configured to determine whether or not an object is disposed on said carrier plate according to the weight signal received from said first weight sensor, so as to control said motors accordingly.

4. The intelligent meal delivery system according to claim 1, wherein said rail device further includes a charging station adapted to be disposed in the pick-up region and disposed on said rail for charging said battery set of said delivering vehicle.

5. The intelligent meal delivery system according to claim 1, wherein said delivering vehicle further includes a driven carrier that is drawn by said locomotive carrier to move along the rail, and that includes a bottom seat, a carrier plate disposed on and above said bottom seat in the height direction and adapted for carrying the foods, and a driven wheel set disposed on and under said bottom seat in the height direction and rotatable along said rail.

6. The intelligent meal delivery system according to claim 5, wherein:
said delivering vehicle further includes a first weighting unit disposed between said bottom seat and said carrier plate of said locomotive carrier, and including a first weight sensor that is disposed under said carrier plate, and that is electrically connected to said controller module, and that is adapted for measuring the total weight of said carrier plate of said locomotive carrier and the foods placed thereon so as to output a weight signal to said controller module accordingly, said controller module being configured to determine whether or not an object is disposed on said carrier plate of said locomotive carrier according to the weight signal received from said first weight sensor, so as to control said motors accordingly; and
said delivering vehicle further includes a second weighting unit disposed between said bottom seat and said carrier plate of said driven carrier, and including a second weight sensor that is disposed under said carrier plate of said driven carrier, that is electrically connected to said controller module, and that is adapted for measuring the total weight of said driven carrier and the foods placed thereon so as to output a weight signal to said controller module accordingly, said controller module being configured to determine whether or not an object is disposed on said carrier plate of said driven carrier according to the weight signal received from said second weight sensor and to control said motors accordingly.

7. The intelligent meal delivery system according to claim 1, wherein said rail includes a guideway for guiding movement of said delivering vehicle and having a horizontal width smaller than that of said locomotive carrier.

8. The intelligent meal delivery system according to claim 7, wherein said rail includes inner and outer side walls horizontally apart from each other to define said guideway therebetween, said locomotive carrier further including a plurality of guiding wheel sets mounted to said bottom seat and said chassis plate, each of said guiding wheel sets including at least one auxiliary wheel that is rotatable about an axis parallel to the height direction and that is in contact with one of said inner and outer side walls of said rail to facilitate movement of said locomotive carrier along said rail.

9. The intelligent meal delivery system according to claim 1, wherein said controller module of said controller device stores a delivery map including a plurality of position codes that correspond respectively to said position tags, the instruction transmitted from said operating portion of said operating device including one of said position codes, said controller module being configured to control said motors to move said locomotive carrier toward one of said position tags corresponding to said one of said position codes included in the instruction, and to control said motors to stop driving said main wheels when said detector module detects the one of said position tags corresponding to said one of said position codes included in the instruction.
